(19) United States
(12) Patent Application Publication
(10) Pub. No.: US 2026/0173024 A1
(43) Pub. Date: Jun. 18, 2026

(54) AUTONOMOUS DRONE-BASED SPECTRUM MAPPING AND INTERFERENCE LOCALIZATION SYSTEM

(71) Applicant: Saurabh Hitendra PATEL, Hopkins, MN (US)

(72) Inventor: Saurabh Hitendra PATEL, Hopkins, MN (US)

(21) Appl. No.: 19/538,613

(22) Filed: Feb. 12, 2026

(51) Int. Cl. H04W 64/00; H04W 24/08

(52) U.S. Cl. CPC H04W 64/00; H04W 24/08

(57) ABSTRACT

An autonomous drone-based spectrum mapping and interference localization system and method thereof is disclosed, comprising an unmanned aerial vehicle structure carrying an integrated sensing unit, positioning unit, processor, storage unit, and communication unit configured to monitor radio frequency activity across a geographic region. The sensing unit is configured to receive radio frequency signals across multiple frequency bands through directional and omnidirectional antenna arrangements, while the positioning unit determines spatial coordinates and altitude of the unmanned aerial vehicle during movement. The processor is configured to associate acquired signal measurements with positional data to generate a spatial distribution representation of spectrum usage and to identify abnormal signal variations indicative of interference. The processor further determines a probable geographic origin of interference sources by correlating signal intensity gradients and directional measurements collected at multiple positions and altitudes.

### TECHNICAL FIELD OF THE INVENTION

The present invention relates generally to the field of wireless communication monitoring, radio frequency spectrum analysis, and autonomous aerial sensing technologies. More particularly, the invention relates to an autonomous drone-based system, a structural device arrangement, and an associated method for dynamic spectrum mapping, real-time interference detection, geospatial localization of signal anomalies, and adaptive reporting through an integrated aerial platform equipped with sensing, positioning, and processing units.

### BACKGROUND OF THE INVENTION

With the rapid proliferation of wireless communication networks, including cellular systems, satellite links, Wi-Fi infrastructures, and IoT deployments, the radio frequency spectrum has become increasingly congested. Unauthorized transmissions, unintentional interference sources, and signal leakage from faulty equipment can significantly degrade communication performance. Traditional spectrum monitoring techniques rely on fixed ground-based stations that provide limited spatial resolution and are often incapable of detecting transient or geographically distributed interference sources. Mobile ground vehicles offer improved coverage but suffer from restricted accessibility, especially in urban, mountainous, or disaster-affected environments.

There exists a need for an adaptive, mobile, and high-resolution spectrum mapping solution capable of operating autonomously over large geographic areas. Such a system must be capable of capturing real-time spectrum characteristics, identifying anomalous emissions, and accurately determining the location of interference sources. The integration of aerial platforms with onboard sensing and computation enables flexible and scalable monitoring of the radio environment. However, existing aerial monitoring arrangements lack precise interference localization capabilities, structured sensing device configurations, and coordinated mapping methods for dynamic environments.

The exponential growth in wireless communication technologies over the past two decades has led to an unprecedented demand for efficient utilization and monitoring of the radio frequency spectrum. Modern societies rely heavily on wireless networks for telecommunications, broadcasting, satellite communications, navigation, industrial automation, and Internet of Things connectivity. With increasing density of wireless transmitters operating across multiple frequency bands, the radio spectrum has become a highly congested and complex environment. This congestion has given rise to significant challenges related to spectrum interference, unauthorized transmissions, signal leakage, and performance degradation in communication networks. In many scenarios, interference may be caused unintentionally by malfunctioning equipment, poorly configured transmitters, or overlapping frequency allocations, while in other cases it may result from deliberate unauthorized usage. Effective spectrum monitoring and interference localization have therefore become critical requirements for regulatory authorities, network operators, defense agencies, and emergency services.

Conventional spectrum monitoring solutions primarily rely on fixed ground-based monitoring stations installed at strategic locations. These stations typically consist of high-sensitivity receivers, antenna arrays, and signal analysis equipment configured to measure signal strength, frequency occupancy, and modulation characteristics across designated bands. While fixed monitoring stations provide continuous observation over specific geographic regions, they suffer from limited spatial coverage. Their performance is highly dependent on line-of-sight conditions, and signal detection capabilities may be affected by terrain obstacles such as buildings, hills, and dense vegetation. As a result, interference sources located in shadowed areas or behind obstructions often remain undetected. Furthermore, the installation and maintenance of fixed stations require significant infrastructure investment, making it impractical to deploy them at high density over large geographic areas.

Another widely used approach involves the use of mobile ground-based monitoring units mounted on vehicles. These mobile systems are equipped with spectrum analyzers, antenna assemblies, and positioning systems, allowing operators to travel across areas of interest and collect signal measurements at different locations. While mobile ground units improve spatial coverage compared to fixed installations, their effectiveness is restricted by accessibility constraints. Urban congestion, rough terrain, restricted zones, and disaster-affected regions can limit vehicle mobility and delay data collection. Additionally, ground-based measurements are often influenced by reflections and signal multipath effects caused by surrounding structures, which can distort signal strength readings and complicate interference source localization. The process of manually navigating vehicles to suspected interference zones can also be time-consuming and labor-intensive.

Existing spectrum mapping solutions have also incorporated handheld portable monitoring devices carried by technicians. These devices allow field personnel to perform on-site signal analysis and identify potential interference sources. However, handheld devices require human presence in the field and are limited in terms of coverage and endurance. They are particularly ineffective for monitoring large or hazardous areas where physical access is restricted. In emergency scenarios such as natural disasters, industrial accidents, or security incidents, deploying personnel for spectrum monitoring may be unsafe or impractical. Additionally, the data collected by handheld devices often lacks comprehensive spatial context, making it difficult to generate detailed coverage maps.

In recent years, there has been growing interest in using aerial platforms for spectrum monitoring, including manned aircraft and tethered balloons equipped with sensing equipment. Aircraft-based monitoring systems can cover large areas and capture signals from elevated vantage points, improving line-of-sight detection capabilities. However, operating manned aircraft for routine spectrum monitoring is expensive and requires trained personnel, fuel, and regulatory clearances. The operational costs and logistical complexity limit the frequency and duration of monitoring missions. Tethered balloons offer extended observation duration but lack mobility and are highly susceptible to weather conditions. Their fixed position limits their ability to investigate multiple areas or track moving interference sources.

Another category of existing solutions involves distributed sensor networks deployed across multiple ground locations. These systems consist of interconnected sensing nodes that continuously monitor spectrum usage and transmit collected data to a central processing facility. While distributed networks can provide broad coverage, they require substantial infrastructure deployment and maintenance. Synchronization among sensor nodes is also challenging, and inconsistent calibration across nodes can lead to inaccuracies in signal measurements. In addition, these systems often struggle to adapt to rapidly changing spectrum conditions, and their fixed nature limits their ability to investigate emerging interference sources in real time.

Traditional interference localization techniques rely heavily on signal strength comparison, time difference of arrival, and angle of arrival methods using multiple fixed receivers. Although these techniques can estimate the location of a signal source, their accuracy depends on the density and geometric distribution of sensing nodes. Sparse deployment can lead to large localization errors, particularly in complex environments where signals experience attenuation, reflection, and scattering. Furthermore, establishing a synchronized network of multiple receivers requires precise timing coordination and high infrastructure costs.

With the increasing adoption of unlicensed wireless technologies such as Wi-Fi, Bluetooth, and low-power IoT devices, the spectrum environment has become more dynamic and unpredictable. Many interference events are transient and localized, making them difficult to detect using static monitoring systems. Interference may occur sporadically due to temporary device operation, environmental changes, or short-duration transmissions. Existing monitoring solutions often fail to capture such transient events because they are not positioned close enough to the interference source at the right time. As a result, regulatory authorities and network operators may struggle to identify the root cause of performance issues.

Another drawback of existing solutions is the lack of real-time adaptability. Most conventional systems operate based on predefined monitoring schedules or fixed measurement points. They do not possess the capability to autonomously adjust their observation strategy based on detected anomalies. When interference is detected, additional manual investigation is typically required to pinpoint its origin. This reactive approach leads to delays in interference mitigation and prolonged disruption to communication services.

Moreover, current spectrum monitoring systems often lack integration between data acquisition and geospatial mapping. While signal measurements may be recorded with location tags, the process of generating detailed spatial coverage maps and identifying interference hotspots often requires post-processing at centralized facilities. This separation between data collection and analysis reduces operational efficiency and delays decision-making. In many cases, by the time analysis is completed, the interference event may have already subsided or changed location.

Environmental and operational factors also pose challenges for conventional monitoring systems. Urban environments with dense infrastructure create complex signal propagation conditions, leading to shadowing and multipath effects that complicate localization efforts. Rural and remote areas may lack adequate infrastructure for deploying fixed monitoring stations. Additionally, in scenarios involving border surveillance, disaster response, or security operations, rapid deployment of monitoring systems is essential, but existing solutions are not designed for quick and flexible deployment.

In recent years, unmanned aerial vehicles have been explored for various sensing and surveillance applications due to their mobility, flexibility, and ability to access hard-to-reach areas. Some experimental systems have used drones equipped with basic spectrum analyzers to perform aerial surveys. However, these implementations are often limited in functionality and lack structured integration between sensing, positioning, and analysis components. Many such systems rely on manual control, which reduces operational efficiency and increases dependence on skilled operators. Furthermore, the lack of standardized structural arrangements for mounting sensing equipment on drones can lead to instability, vibration-induced measurement errors, and electromagnetic interference from onboard electronics.

Another limitation of current aerial spectrum monitoring approaches is the absence of coordinated measurement strategies for accurate interference localization. Collecting signal measurements from a single aerial position provides limited information about the direction and distance of a signal source. Without systematic multi-point data acquisition and correlation, it is difficult to precisely determine the location of interference emitters. Existing drone-based experiments have also struggled with data synchronization, power management, and maintaining consistent measurement accuracy during flight.

There is therefore a significant need for a comprehensive solution that overcomes the limitations of fixed, ground-based, and manually operated monitoring systems. Such a solution should provide high spatial resolution, real-time adaptability, and the ability to access diverse geographic areas. It should enable automated data collection, integration of positional and spectral information, and accurate localization of interference sources. Additionally, the solution should incorporate a structurally stable sensing device configuration capable of maintaining measurement fidelity under dynamic flight conditions. The development of an autonomous drone-based system that integrates spectrum sensing, geospatial mapping, and interference localization represents a promising direction to address these challenges and improve the effectiveness of spectrum monitoring in increasingly complex wireless environments.

### SUMMARY OF THE INVENTION

The present invention provides an autonomous drone-based spectrum mapping and interference localization system and method thereof, comprising a device structure integrated into an unmanned aerial vehicle for sensing, processing, and geospatial mapping of radio frequency signals. The system includes a structural device mounted onto the drone body, comprising a sensing unit configured to capture multi-band radio frequency signals, a positioning unit configured to determine spatial coordinates, and a processing unit configured to analyze spectral characteristics and identify interference sources. The method involves autonomous flight path execution, continuous spectrum sampling, spatial tagging of measured signal parameters, and triangulation-based localization of interference emitters.

The invention further provides a machine-integrated device structure comprising a housing assembly configured to support directional and omnidirectional antenna elements, signal acquisition circuitry, and vibration-isolated mounting brackets designed to maintain sensing accuracy during flight. The structural configuration ensures stable operation under variable environmental conditions and enhances signal reception fidelity. The system operates in a coordinated manner to generate a spatially resolved spectrum map and determine interference source positions through multi-point measurement correlation.

The primary object of the present invention is to provide an autonomous drone-based spectrum mapping and interference localization system and method thereof that enables efficient monitoring of radio frequency activity across a wide geographical area through an integrated aerial platform. The invention aims to create a machine-integrated sensing device structure capable of capturing multi-band radio signals during flight and generating spatially referenced spectrum data in real time. By combining aerial mobility with advanced signal acquisition and positional awareness, the invention seeks to overcome the limitations of static and ground-based monitoring approaches and provide a more flexible and responsive solution for spectrum analysis.

Another object of the invention is to provide a structurally stable and compact device arrangement that can be mounted on an unmanned aerial vehicle without affecting flight stability while ensuring accurate and consistent signal measurements. The invention aims to establish a robust structural configuration that minimizes the impact of vibration, electromagnetic noise, and environmental disturbances on sensing components. Through this structural integration, the system is intended to maintain reliable signal reception and analysis during dynamic aerial operations.

A further object of the invention is to enable real-time detection and localization of interference sources by capturing spectrum data from multiple spatial points during autonomous flight. The invention seeks to provide a coordinated mechanism for collecting signal measurements along predefined or dynamically adjusted flight paths, associating each measurement with positional data, and determining the likely origin of interference through spatial correlation and analysis. This capability is intended to assist regulatory authorities, network operators, and security agencies in identifying unauthorized transmissions and resolving performance issues in wireless communication systems.

Another object of the invention is to provide an automated spectrum mapping capability that generates a comprehensive representation of frequency usage across a monitored region. The invention aims to continuously collect and process signal data while the aerial platform moves through the area, thereby producing a spatial distribution profile of signal strength, frequency occupancy, and noise levels. This mapping function is intended to support planning, optimization, and management of wireless networks by offering a detailed understanding of spectrum utilization patterns.

An additional object of the invention is to provide a system that can operate autonomously with minimal human intervention by incorporating positioning, navigation, and processing functionalities within the integrated device structure. The invention seeks to enable automatic execution of monitoring missions, data acquisition, and preliminary analysis during flight, thereby reducing the need for manual control and on-site personnel. This object is particularly important for operations in remote, hazardous, or restricted environments where conventional monitoring methods are difficult to implement.

Another object of the invention is to enhance the accuracy of interference localization by utilizing measurements collected from varying altitudes and positions. The invention aims to take advantage of aerial mobility to capture signal variations from multiple perspectives, thereby improving the reliability of localization estimates. By integrating sensing and positional data, the system is intended to provide more precise identification of interference hotspots compared to existing ground-based techniques.

A further object of the invention is to provide a modular and adaptable device structure that can support different frequency bands and sensing configurations. The invention aims to accommodate various monitoring requirements by allowing integration of additional sensing elements, thereby making the system suitable for multiple applications including telecommunications monitoring, security surveillance, and environmental signal assessment. This adaptability is intended to ensure that the system remains relevant in evolving spectrum environments.

Another object of the invention is to provide real-time communication of collected data to a ground-based receiving system, enabling immediate visualization and analysis of spectrum conditions. The invention seeks to ensure that decision-makers can access up-to-date information regarding interference events and spectrum occupancy, facilitating faster response and mitigation actions. This objective supports improved operational efficiency and timely resolution of communication disruptions.

An additional object of the invention is to provide a reliable and scalable solution that can be deployed rapidly in diverse operational scenarios. The invention aims to enable flexible deployment across urban, rural, and remote areas without the need for extensive infrastructure setup. By utilizing an aerial platform with an integrated sensing device structure, the system is intended to provide a practical alternative to conventional monitoring systems that require permanent installations.

Another object of the invention is to improve the overall effectiveness of spectrum monitoring by combining structural stability, autonomous operation, and integrated data processing within a single system. The invention seeks to create a comprehensive arrangement that not only captures and analyzes radio frequency data but also identifies the location of interference sources in a systematic and efficient manner. Through these objectives, the invention aims to contribute to better management of wireless communication resources, improved network performance, and enhanced regulatory oversight of spectrum usage.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for an autonomous drone-based spectrum mapping and interference localization system; and

FIG. 2 displays flow chart of a method for a method for autonomous drone-based spectrum mapping and interference localization using a system mounted on an unmanned aerial vehicle.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

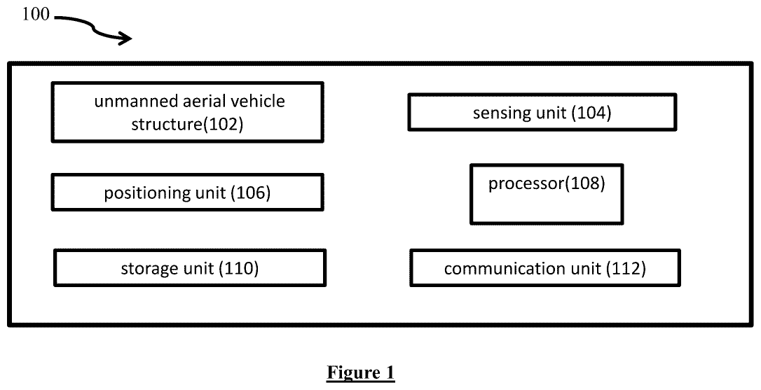

Referring to FIG. 1, a block diagram of an autonomous drone-based spectrum mapping and interference localization system, the system comprising: an unmanned aerial vehicle structure (102); a sensing unit (104) secured to the unmanned aerial vehicle structure and configured to receive radio frequency signals across multiple frequency bands through at least one directional antenna (104a) and at least one omnidirectional antenna; a positioning unit (106) configured to determine geographic coordinates, altitude, and motion parameters of the unmanned aerial vehicle; a processor (108) operatively connected to the sensing unit and the positioning unit and configured to acquire radio frequency measurements and associate the radio frequency measurements with spatial location data; a storage unit (110) configured to store collected spectrum data and associated positional information; and a communication unit (112) configured to transmit processed spectrum information to a remote receiving station, wherein the processor is further configured to generate a spatial spectrum distribution map and determine a location of an interference source based on variations in signal strength and directional measurements obtained during flight.

In an embodiment, the sensing unit (102) comprises a wideband receiver arrangement mounted within a vibration-isolated enclosure fixed to the unmanned aerial vehicle structure, the enclosure including electromagnetic shielding layers to reduce electrical noise from propulsion components and maintain signal acquisition accuracy during flight.

In an embodiment, the directional antenna (104a) is mounted on a stabilized support assembly that maintains angular alignment during movement of the unmanned aerial vehicle, and wherein the processor is configured to determine direction of arrival of received signals based on angular measurements associated with the directional antenna orientation.

In an embodiment, the positioning unit (106) comprises a satellite navigation receiver integrated with an altitude sensing element and a motion detection element, and wherein the processor is configured to synchronize positional data with radio frequency measurements collected at corresponding time intervals to enable spatial tagging of each measurement.

In an embodiment, the processor (108) is configured to continuously compare signal strength measurements obtained at different spatial locations along a flight path to identify regions of abnormal signal concentration indicative of interference activity.

In an embodiment, the processor (108) is further configured to estimate a probable geographic origin of an interference source by correlating directional measurements with signal intensity gradients recorded at multiple positions of the unmanned aerial vehicle during movement across a monitored region.

In an embodiment, the sensing unit (102) comprises a plurality of antenna elements arranged in a spaced configuration on the unmanned aerial vehicle structure to provide spatial diversity in signal reception, and wherein the processor is configured to analyze differences in received signal parameters across the plurality of antenna elements to improve localization accuracy.

In an embodiment, the storage unit (110) comprises a non-volatile memory arranged to record time-stamped spectrum measurements together with corresponding geographic coordinates, altitude data, and motion parameters to enable reconstruction of a spatially resolved spectrum map after completion of a flight sequence.

In an embodiment, the communication unit (112) is configured to transmit processed data packets containing spectrum occupancy information, interference indicators, and geographic reference points to the remote receiving station in real time using a wireless communication link.

In an embodiment, the processor (108) is configured to generate a dynamic coverage map representing frequency usage distribution over a monitored area by integrating sequential radio frequency measurements collected at different flight positions.

In an embodiment, the processor is configured to implement a coordinated measurement sequencing operation in which the sensing unit is triggered to acquire radio frequency measurements at successive spatial intervals determined from motion parameters obtained from the positioning unit, the processor further associating each acquired measurement with a corresponding spatial reference by aligning time-stamped signal acquisition instances with positional updates so as to generate a continuous spatial record of frequency occupancy as the unmanned aerial vehicle traverses the monitored region.

In an embodiment, the processor performs a coordinated measurement sequencing operation by continuously monitoring the motion parameters received from the positioning unit, including instantaneous velocity, directional movement, and positional displacement, and using this information to determine when the sensing unit should be activated to acquire radio frequency measurements. Instead of relying on fixed periodic acquisition intervals, the processor evaluates how far the unmanned aerial vehicle has physically moved from the last recorded measurement point and triggers the sensing unit only after a defined spatial displacement has occurred. This spatially governed triggering ensures that measurements are evenly distributed across the geographic area regardless of changes in speed, hovering conditions, or directional variations. The processor maintains a displacement tracking routine in which it compares the current positional coordinates with previously recorded coordinates and determines whether the predefined spatial threshold has been crossed. Once this condition is met, a measurement command is issued to the sensing unit to capture radio frequency signals across the designated bands.

Simultaneously, the processor aligns each acquired measurement with a precise spatial reference by synchronizing time-stamped signal acquisition events with the corresponding positional updates obtained from the positioning unit. Each signal measurement is assigned a time reference at the instant of acquisition, and the processor retrieves the nearest positional record corresponding to that time reference, including geographic coordinates, altitude, and motion state. Through this alignment, each measurement becomes directly associated with a specific point in space. This process continues throughout the flight, forming a sequence of spatially indexed records that represent the distribution of radio frequency activity across the monitored region. For example, when the unmanned aerial vehicle moves across an area with varying terrain elevation and signal conditions, the processor ensures that each measurement reflects the actual position and altitude at which it was captured, allowing accurate mapping of signal strength variations across both horizontal and vertical dimensions.

The processor further maintains continuity by organizing the spatially referenced measurements in chronological order and linking each measurement to the next based on the movement trajectory of the unmanned aerial vehicle. This creates a continuous spatial record that captures gradual changes in frequency occupancy as the vehicle traverses the monitored region. When the unmanned aerial vehicle slows down or hovers in a region of interest, the processor adapts the triggering mechanism by evaluating the rate of positional change and ensuring that redundant measurements at nearly identical positions are minimized while still capturing meaningful variations. Conversely, when the unmanned aerial vehicle moves rapidly across a region, the processor increases the frequency of measurement triggers so that spatial gaps in coverage are avoided.

This coordinated sequencing approach enables the sensing unit to acquire measurements that are directly tied to physical movement across space rather than to time alone, resulting in a more accurate and structured representation of radio frequency distribution. In a practical scenario, such as monitoring an urban environment with multiple sources of radio frequency activity, the processor is able to construct a continuous spatial trail of measurements showing how signal intensity and frequency occupancy change as the unmanned aerial vehicle moves along streets, over buildings, and across open areas. The resulting dataset allows the processor to later correlate signal variations with specific geographic positions and movement patterns, supporting more precise interpretation of spatial signal behavior and facilitating the identification of regions with abnormal frequency activity.

In an embodiment, the processor is configured to perform a multi-stage comparison of signal strength measurements obtained at consecutive spatial locations by retrieving previously stored measurements from the storage unit, computing relative variations between newly acquired measurements and stored reference values corresponding to nearby spatial coordinates, and identifying localized clusters of signal intensity increase by analyzing cumulative variation patterns across adjacent measurement points along the flight path.

In an embodiment, the processor performs a multi-stage comparison by first organizing all previously acquired signal strength measurements in the storage unit according to their associated spatial coordinates and time references. As the unmanned aerial vehicle moves to a new position and the sensing unit captures fresh radio frequency data, the processor retrieves stored measurements corresponding to nearby spatial coordinates that fall within a defined proximity range from the current location. This retrieval is carried out by examining coordinate differences and selecting prior records that were captured within a limited spatial radius along the earlier flight path. The processor then establishes a comparison set consisting of the newly acquired measurement and a group of spatially adjacent reference measurements from the storage unit.

Once the comparison set is formed, the processor computes relative variations by determining the difference in signal strength values between the newly acquired measurement and each of the retrieved reference values. The processor evaluates whether the variation represents a gradual increase, a sudden spike, or a consistent pattern across multiple neighboring points. In this stage, the processor considers not only a single comparison but a sequence of measurements along the direction of movement. For example, if the unmanned aerial vehicle is moving across a monitored area and signal strength readings increase steadily over several consecutive spatial locations, the processor identifies this pattern as a directional gradient indicating that the source of the signal is likely in proximity. The processor further evaluates whether the increase is localized to a specific region or dispersed across a wider area by examining cumulative variation trends across adjacent measurement points.

In the next stage, the processor analyzes cumulative variation patterns by arranging the measurements in spatial order and calculating the extent of signal intensity change across consecutive points along the flight path. If multiple adjacent measurement points exhibit progressively increasing signal strength values within the same frequency band, the processor interprets this as the formation of a localized cluster of signal concentration. The processor assigns higher significance to clusters that demonstrate consistency across several consecutive positions rather than isolated peaks at a single point. For instance, if signal intensity values at three or more neighboring spatial locations increase in a consistent manner relative to their stored reference values, the processor identifies this region as a potential interference zone. The processor continues to monitor subsequent measurements to confirm whether the cluster persists or dissipates as the unmanned aerial vehicle moves forward.

In a practical example, while surveying a communication-dense environment, the unmanned aerial vehicle may initially record moderate signal strength levels across a region. As it approaches a location where an interference source is present, newly acquired measurements begin to show higher signal strength compared to earlier stored values from nearby coordinates. The processor retrieves these earlier measurements and calculates the difference for each spatial point. When the processor observes that signal strength values have increased steadily across several adjacent positions, it identifies a cluster pattern that suggests the presence of a localized emitter. If subsequent measurements taken slightly ahead along the flight path continue to show increased intensity, the processor strengthens its assessment by recognizing that the signal concentration is not random but spatially consistent.

The processor further refines this assessment by comparing the rate of increase between consecutive spatial points. If the rate of increase becomes more pronounced as the unmanned aerial vehicle approaches a specific coordinate region, the processor marks this area as having a higher probability of containing an interference source. This step-by-step comparison allows the system to distinguish between normal variations in signal conditions caused by environmental factors and concentrated signal increases indicative of an active source. The cumulative analysis across multiple adjacent points prevents false identification that could occur if only a single measurement were considered.

Through this multi-stage comparison process, the processor continuously updates the interpretation of signal behavior across the monitored region by combining newly acquired measurements with stored spatial references. This approach allows the system to identify areas where signal strength is gradually building across neighboring locations and to isolate these areas as clusters associated with potential interference. The use of cumulative variation analysis across spatially ordered data provides a reliable method to detect and confirm localized signal concentration as the unmanned aerial vehicle progresses along its flight path.

In an embodiment, the processor is configured to estimate the probable geographic origin of the interference source by determining directional reception angles associated with each acquired measurement from the directional antenna orientation data, correlating the directional reception angles with corresponding signal intensity values at multiple spatial positions, and deriving a converging spatial estimate by identifying overlapping directional regions that correspond to progressively increasing signal intensity levels recorded during movement of the unmanned aerial vehicle.

In an embodiment, the processor estimates the probable geographic origin of the interference source by continuously extracting directional reception angles from the orientation data associated with the directional antenna at the instant each radio frequency measurement is acquired. As the unmanned aerial vehicle traverses the monitored region, the orientation of the directional antenna relative to the earth's reference frame is recorded along with signal intensity values. The processor interprets each orientation reading as a directional vector representing the angle from which the strongest component of the received signal is detected at that spatial position. These directional vectors are stored together with the corresponding positional coordinates and signal strength values, creating a set of spatially distributed directional observations across the flight path.

As the unmanned aerial vehicle progresses through successive positions, the processor correlates the directional reception angles with their associated signal intensity levels to identify directional patterns that indicate a consistent source of emission. For each measurement point, the processor evaluates the direction in which the antenna recorded maximum signal strength and projects that direction outward from the geographic coordinate at which the measurement was taken. This process results in multiple directional projections originating from different spatial positions. The processor then examines how these projected directions relate to one another by identifying areas where several directional projections overlap or intersect. When multiple directional observations from different positions consistently point toward the same general geographic region, the processor interprets this region as a probable origin zone for the interference source.

In addition to identifying overlapping directional regions, the processor also considers how signal intensity changes across the flight path. Measurements collected at positions that are geographically closer to the source are expected to exhibit higher signal intensity. The processor therefore evaluates directional observations in conjunction with the corresponding signal strength values, assigning greater significance to directional vectors recorded at positions where signal intensity is comparatively stronger. For example, if directional vectors from earlier flight positions converge toward a particular region but are associated with moderate signal strength, and later vectors from positions closer to that region show increased intensity while maintaining a similar directional orientation, the processor interprets this as confirmation that the unmanned aerial vehicle is moving toward the emission source.

The processor refines the estimation by analyzing directional observations from multiple spatial positions to detect progressive convergence. As the unmanned aerial vehicle changes its position and orientation over time, the directional antenna records different reception angles relative to the source. The processor compares these angles across sequential positions and identifies regions where directional projections from different points increasingly intersect. When the area of intersection becomes smaller and more concentrated, the processor determines that the estimated source location is becoming more precise. This process continues iteratively as new measurements are acquired, with each additional directional observation contributing to narrowing the potential source region.

In a practical scenario, consider the unmanned aerial vehicle moving along a curved path over an area where an unauthorized transmitter is operating. At an initial position, the directional antenna records maximum signal strength when oriented toward a particular compass direction. The processor projects this direction from the initial position to define a possible region where the source may be located. As the unmanned aerial vehicle continues along its path and acquires additional measurements from different positions, the directional antenna again identifies maximum signal reception at angles that, when projected, intersect with the earlier directional projection. At the same time, signal intensity gradually increases as the vehicle approaches the region of overlap. The processor correlates the directional alignment and intensity progression across these positions to derive a converging spatial estimate. With each new measurement, the region of overlap becomes more narrowly defined, allowing the processor to estimate the probable geographic origin of the interference source with increasing precision.

By continuously correlating directional reception angles with corresponding signal intensity values and spatial coordinates, the processor constructs a consistent directional convergence pattern that points toward the emitting source. The use of overlapping directional projections from multiple spatial positions reduces ambiguity that may arise from reflections or temporary signal distortions. The processor's ability to prioritize directional observations associated with higher signal intensity further improves the reliability of the estimated origin. This process enables accurate determination of the source location even when the unmanned aerial vehicle follows a non-linear flight path or operates in environments where signal propagation conditions vary.

In an embodiment, the processor is configured to determine the direction of arrival of received signals by continuously monitoring the orientation of the stabilized support assembly carrying the directional antenna, associating each orientation position with a corresponding signal intensity value, and constructing a directional reception profile over a sequence of spatial positions so as to determine a dominant reception direction corresponding to a suspected interference source.

In an embodiment, the processor determines the direction of arrival of received signals by continuously acquiring orientation information of the stabilized support assembly that carries the directional antenna and correlating this information with the signal intensity values measured by the sensing unit. The stabilized support assembly maintains a known angular position relative to a reference axis of the unmanned aerial vehicle, and the positioning unit provides real-time data regarding heading, tilt, and rotational movement. The processor receives this orientation data at the same instant the sensing unit captures signal measurements, thereby creating paired records in which each signal intensity value is linked to a specific antenna orientation angle and a precise spatial coordinate.

As the unmanned aerial vehicle moves through the monitored region, slight variations in its movement, turning behavior, and environmental forces cause the orientation of the directional antenna to change incrementally. At each of these orientation states, the sensing unit records the strength of received signals across the monitored frequency bands. The processor accumulates these readings over a sequence of spatial positions and arranges them in relation to their corresponding antenna orientations. This arrangement enables the processor to construct a directional reception profile in which signal intensity values are plotted in relation to angular positions recorded during movement. Through this process, the processor identifies which orientation angles consistently correspond to higher signal intensity levels.

The processor further refines this directional reception profile by analyzing how signal intensity changes as the antenna orientation shifts across different angular positions. If, over multiple spatial positions, the sensing unit records peak signal intensity whenever the antenna is oriented toward a particular angular sector, the processor identifies this sector as the dominant reception direction. For example, as the unmanned aerial vehicle follows its flight path, the antenna may face various directions due to controlled maneuvering or stabilization adjustments. At each orientation, the sensing unit captures signal strength readings. If the processor observes that the highest signal levels are consistently associated with orientations pointing toward the same geographic direction across several positions, it interprets this as an indication that the source of the signal lies along that directional path.

The processor constructs the directional reception profile by aggregating multiple orientation-linked measurements collected over time. Rather than relying on a single measurement instance, the processor considers a sequence of orientation states and their corresponding signal intensity values. This sequential analysis allows the processor to filter out temporary fluctuations caused by reflections, noise, or transient signals. For instance, if an isolated measurement shows high signal intensity at a particular orientation but subsequent measurements at nearby positions do not support that direction, the processor treats it as a temporary anomaly. However, when repeated measurements across different spatial positions consistently show higher signal intensity at similar orientation angles, the processor strengthens the confidence in identifying that direction as dominant.

As the unmanned aerial vehicle continues to move, the processor updates the directional reception profile by incorporating newly acquired orientation-linked signal measurements. Over time, this results in a refined directional pattern that highlights a stable angular region associated with peak signal reception. The processor then associates this dominant reception direction with the geographic orientation of the unmanned aerial vehicle at the time of measurement. By combining orientation data with positional coordinates, the processor determines the direction in which the suspected interference source is located relative to the vehicle's current position.

In a practical example, when the unmanned aerial vehicle passes through an area where an interference source is active, the directional antenna may detect stronger signals whenever it faces toward a particular direction. As the vehicle travels along its route, the antenna orientation changes due to turns or stabilization adjustments, but the processor continues to observe that the highest signal strength values occur when the antenna aligns with a consistent directional sector. By constructing and updating the directional reception profile over these multiple positions, the processor is able to determine that this angular sector corresponds to the direction from which the interference signal is arriving.

Through this continuous monitoring and correlation process, the processor is able to derive a stable and reliable estimate of the direction of arrival by associating orientation-linked signal intensity values across a sequence of spatial positions. This approach allows the system to maintain directional awareness even when the unmanned aerial vehicle is in motion, and it provides a basis for subsequent localization operations by identifying the dominant direction toward the suspected interference source.

In an embodiment, the processor is configured to synchronize positional data with radio frequency measurements by assigning time-referenced identifiers to each positional update received from the positioning unit and aligning the time-referenced identifiers with corresponding signal acquisition events from the sensing unit so that each measurement is tagged with geographic coordinates, altitude data, and motion parameters representing the exact spatial state of the unmanned aerial vehicle at the moment of acquisition.

In an embodiment, the processor synchronizes positional data with radio frequency measurements by maintaining a continuous time-referenced sequencing routine that links each signal acquisition event with the exact positional state of the unmanned aerial vehicle at the moment the measurement is captured. The positioning unit continuously generates positional updates containing geographic coordinates, altitude values, velocity information, and directional movement parameters. Each of these updates is assigned a distinct time-referenced identifier by the processor, representing the precise instant at which the spatial state of the unmanned aerial vehicle is recorded. Simultaneously, the sensing unit captures radio frequency measurements and generates corresponding time-referenced acquisition instances. The processor establishes alignment between these two streams of time-referenced data by matching the signal acquisition instance with the nearest positional update in time, thereby ensuring that each signal measurement is accurately associated with the spatial parameters present at the exact moment of capture.

To maintain precision in this synchronization process, the processor continuously maintains a rolling sequence of recent positional updates in temporary memory, each labeled with its corresponding time reference. When a signal measurement is received from the sensing unit, the processor identifies the positional record whose time reference most closely corresponds to the measurement acquisition instant. The processor then attaches the geographic coordinates, altitude data, and motion parameters from that positional record to the signal measurement entry. In cases where positional updates occur at a higher frequency than signal acquisitions, the processor selects the positional record that falls within a minimal time difference range from the acquisition event. In situations where signal acquisition occurs at a higher frequency than positional updates, the processor interpolates between the two nearest positional records in time to determine an accurate spatial reference. This approach ensures that each signal measurement is consistently tagged with a spatial state that reflects the unmanned aerial vehicle's true position and motion at the time of sensing.

As the unmanned aerial vehicle moves through the monitored region, this synchronization process creates a structured dataset in which each radio frequency measurement is directly associated with its corresponding geographic location, altitude, and movement direction. For example, when the vehicle is traveling along a curved path or changing altitude, positional parameters can vary significantly within short time intervals. By aligning each measurement with the precise positional state recorded at the moment of acquisition, the processor ensures that variations in signal strength are correctly attributed to specific spatial positions rather than being averaged or misaligned due to time discrepancies. This is particularly important when constructing a spatial map of frequency occupancy, as even small positional inaccuracies could result in incorrect mapping of signal intensity distribution.

In a practical scenario, consider the unmanned aerial vehicle flying over an area where multiple communication sources are active at different elevations and positions. The sensing unit may capture a sudden increase in signal strength within a particular frequency band. The processor immediately references the time-stamped acquisition event and retrieves the positional update that corresponds to that instant, which may indicate a specific coordinate location and altitude. The measurement is then stored with this exact spatial reference, allowing the processor to later determine whether the signal increase was associated with a ground-based source, an elevated transmitter, or a source located at a particular geographic position along the flight path.

Over the course of the flight, the processor continues this alignment process for every acquired measurement, resulting in a continuous series of spatially tagged signal records that reflect the exact spatial state of the unmanned aerial vehicle at each acquisition moment. This time-aligned tagging allows the processor to compare measurements collected at different positions with high accuracy, as each record represents a precise spatial reference point. The synchronized dataset also supports later processing steps, such as analyzing signal intensity gradients across positions, correlating directional reception patterns with location data, and refining interference source estimation. The close alignment between positional updates and signal acquisition events ensures that the spatial mapping of radio frequency activity reflects the true distribution of signals across the monitored region and that subsequent localization operations are based on accurately referenced measurements.

In an embodiment, the processor is configured to analyze differences in received signal parameters across the plurality of antenna elements by simultaneously acquiring signal measurements from each antenna element, comparing relative signal strength values received at each antenna element at the same time instance, and determining spatial reception gradients across the antenna arrangement so as to derive additional directional information associated with a detected interference source.

In an embodiment, the processor analyzes differences in received signal parameters across the plurality of antenna elements by coordinating simultaneous acquisition of signal measurements from each antenna element at the same acquisition instant, ensuring that all readings correspond to the same spatial position and environmental condition. The sensing unit is arranged to capture signal strength values and associated parameters from each antenna element without temporal delay between them, and the processor assigns a common time reference to the set of measurements obtained from the different antenna elements. This synchronized acquisition allows the processor to treat the set of measurements as a spatial snapshot of signal reception across the antenna arrangement at a particular moment during flight.

Once the simultaneous measurements are obtained, the processor compares the relative signal strength values received at each antenna element to determine how the incoming signal is distributed across the antenna arrangement. Since each antenna element is positioned at a slightly different location and orientation on the unmanned aerial vehicle structure, variations in received signal intensity across the elements indicate differences in the direction from which the signal is arriving. The processor evaluates these variations by calculating the relative differences in signal strength between pairs of antenna elements and observing which antenna element consistently records stronger reception at the same acquisition instant. This comparison enables the processor to detect the presence of a spatial reception gradient across the antenna arrangement.

The processor then interprets the spatial reception gradient as an indication of directional bias in the incoming signal. For example, if one antenna element repeatedly records higher signal strength compared to others at the same time instance, the processor determines that the signal source is located closer to the spatial direction toward which that antenna element is oriented. If multiple antenna elements show gradually increasing signal strength values across their arrangement, the processor recognizes this as a gradient pattern indicating that the signal is approaching from a specific side of the unmanned aerial vehicle. This gradient is derived by arranging the antenna elements in their spatial order and evaluating how signal intensity changes across the arrangement from one element to another.

To strengthen the reliability of this directional inference, the processor accumulates multiple sets of simultaneous measurements collected over successive acquisition instances as the unmanned aerial vehicle moves through the monitored region. By comparing the spatial reception gradients across several time instances and positions, the processor identifies consistent patterns where certain antenna elements repeatedly register higher signal strength. These recurring patterns allow the processor to derive additional directional information about the location of the interference source, complementing the directional data obtained from the directional antenna. For instance, if during multiple acquisition instances one side of the antenna arrangement consistently records stronger signals, the processor interprets this as an indication that the interference source lies in that general direction relative to the vehicle's orientation.

In a practical example, when the unmanned aerial vehicle approaches an area where an interference source is present, the antenna element positioned on the side of the vehicle facing the source may record higher signal strength values compared to antenna elements on the opposite side. As the vehicle continues to move, the processor monitors how these relative differences change. If the gradient shifts in a predictable manner as the vehicle changes position, the processor uses this change to infer whether the vehicle is moving closer to or away from the source. By continuously analyzing the distribution of signal strength across the antenna arrangement, the processor derives directional cues that help narrow down the possible location of the interference source.

This approach allows the processor to extract directional information even when the directional antenna is not actively aligned with the source. The comparison of simultaneous measurements across the plurality of antenna elements provides a complementary spatial perspective that improves interpretation of signal behavior. By using synchronized acquisition and relative comparison of signal strength values across the antenna arrangement, the processor establishes a spatial gradient that reflects the directional tendency of the incoming signal. Over time, as more measurements are collected, the processor refines this directional interpretation and integrates it with other spatial and positional data to support more accurate identification of the interference source location.

In an embodiment, the processor is configured to store time-stamped spectrum measurements in the storage unit in a structured sequence such that each stored record includes a positional coordinate reference, altitude information, directional antenna orientation, and corresponding signal parameters, and wherein the processor retrieves and organizes the stored records in chronological order to reconstruct a spatially resolved representation of spectrum activity over the monitored region.

In an embodiment, the processor stores time-stamped spectrum measurements in the storage unit by creating a structured sequence of data records in which each record is formed at the moment a signal acquisition event occurs and is immediately associated with spatial and orientation information corresponding to that instant. Each time the sensing unit captures a radio frequency measurement, the processor assigns a time reference and combines the measured signal parameters with the corresponding positional coordinates obtained from the positioning unit, the altitude data representing the vertical position of the unmanned aerial vehicle, and the orientation information of the directional antenna at the moment of reception. The processor then constructs a unified data record containing all these parameters and stores it in the storage unit in sequential order based on the acquisition time. This arrangement ensures that the dataset reflects the exact spatial and directional context in which each signal measurement was obtained.

The structured storage process is carried out continuously as the unmanned aerial vehicle moves through the monitored region. The processor maintains a sequential indexing arrangement in which each stored record is placed in chronological order according to its time reference. This sequencing is important because it preserves the spatial progression of the unmanned aerial vehicle along its flight path. For example, as the vehicle travels from one geographic coordinate to another, the processor stores successive measurements in a way that reflects the movement trajectory, allowing later retrieval to follow the same spatial order in which the data was collected. Each record therefore acts as a spatial marker containing a snapshot of frequency activity at a specific position, altitude, and antenna orientation.

When reconstruction of the spatially resolved representation of spectrum activity is required, the processor retrieves the stored records and organizes them in chronological order to reestablish the sequence of spatial measurements collected during the flight. The processor examines each record in the order of its time reference and maps the stored signal parameters to their corresponding positional coordinates and altitude values. By placing these mapped values along the recorded trajectory of the unmanned aerial vehicle, the processor generates a continuous representation of signal distribution across the monitored region. This reconstruction process enables identification of how frequency occupancy changes as a function of geographic location and altitude.

In practical operation, if the unmanned aerial vehicle travels over an area with varying signal environments, the stored records may show that signal intensity increases gradually as the vehicle approaches a specific location and decreases as it moves away. When the processor retrieves and organizes the records, it uses the positional coordinates to plot the signal parameters along the flight path, thereby reconstructing the spatial distribution of spectrum activity. The inclusion of altitude data allows the processor to distinguish between signals received at different vertical levels, enabling the interpretation of whether certain signals are associated with ground-based transmitters or elevated sources. Similarly, the stored directional antenna orientation data provides additional context that allows the processor to associate variations in signal intensity with specific reception angles.

The structured sequence of stored records also supports comparative analysis across different segments of the monitored region. For instance, the processor can retrieve records corresponding to a particular geographic zone and examine how signal characteristics change over time as the unmanned aerial vehicle passes through that zone. By organizing the records in chronological order, the processor maintains the temporal continuity of measurements, allowing it to detect patterns such as repeated increases in signal strength at specific coordinates or gradual transitions in frequency occupancy along the flight path.

This organized storage and retrieval process enables the processor to reconstruct a spatially resolved representation of spectrum activity that reflects both the physical movement of the unmanned aerial vehicle and the corresponding variations in signal conditions. Because each stored record contains a complete set of spatial, altitude, orientation, and signal parameters, the processor can accurately recreate the measurement environment and correlate signal behavior with specific positions in space. Over multiple flights, additional sets of structured records can be accumulated and compared, allowing the processor to identify consistent spatial patterns, monitor recurring interference zones, and refine localization estimates based on previously recorded data.

In an embodiment, the processor is configured to generate the dynamic coverage map by aggregating sequential radio frequency measurements collected at different flight positions, grouping the measurements based on spatial proximity, and computing localized frequency occupancy values for each grouped spatial region based on cumulative signal data associated with the corresponding geographic coordinates.

In an embodiment, the processor generates the dynamic coverage map by first collecting a continuous sequence of radio frequency measurements as the unmanned aerial vehicle traverses the monitored region and then organizing these measurements according to their associated geographic coordinates and altitude references. Each measurement captured by the sensing unit is stored with positional tagging, and the processor uses this spatial information to determine how closely individual measurements are located relative to one another. The processor identifies groups of measurements that fall within a defined geographic proximity range, treating these groups as representing localized spatial regions through which the unmanned aerial vehicle has passed. By grouping measurements that correspond to nearby positions, the processor ensures that the data contributing to each region reflects signal conditions within a consistent area rather than being dispersed across distant points.

Once spatial grouping is established, the processor computes localized frequency occupancy values by evaluating cumulative signal data associated with each grouped region. For every spatial group, the processor examines the set of stored signal measurements linked to that region and assesses the presence and intensity of radio frequency activity across the monitored bands. The processor determines how frequently signals are detected within specific frequency ranges and how the strength of those signals varies within the spatial group. By analyzing the combined signal measurements for that area, the processor forms a representation of how actively particular frequency bands are being used at that location. This cumulative assessment allows the processor to derive a localized occupancy profile that reflects both the presence and persistence of radio frequency transmissions within the grouped spatial region.

As the unmanned aerial vehicle continues to move and collect additional measurements, the processor updates the coverage map by integrating newly acquired data into the existing spatial groups. When the vehicle revisits an area or passes close to previously measured locations, the processor adds the new signal measurements to the existing group associated with that spatial region. The cumulative nature of this aggregation allows the coverage map to become more refined over time, as repeated measurements from similar positions provide a more representative picture of frequency usage. For example, if the vehicle passes over an area where intermittent transmissions occur, initial measurements may show sporadic activity, but as more data points are collected during subsequent passes, the processor can more accurately determine whether the activity is consistent, transient, or localized to a specific point.

The processor also accounts for altitude variations when grouping measurements. Measurements captured at similar horizontal positions but different vertical levels are compared to understand how signal conditions vary across elevation. This allows the processor to differentiate between signals that are stronger near the ground and those that remain consistent at higher altitudes. By incorporating altitude-associated signal data into the grouping process, the processor produces a more comprehensive representation of radio frequency activity within a three-dimensional space. This contributes to a coverage map that reflects both horizontal and vertical distribution of signal presence across the monitored region.

In practical use, as the unmanned aerial vehicle moves across an urban environment, it collects a series of measurements over streets, buildings, and open areas. The processor groups measurements taken over the same street segment or building cluster and calculates cumulative signal presence for those locations. If a particular frequency band is consistently detected within one grouped region but not in surrounding regions, the processor identifies that location as having a concentrated level of frequency occupancy. Over time, as more measurements are aggregated, the map becomes more detailed, showing variations in frequency usage from one spatial region to another.

The resulting dynamic coverage map is formed by organizing these localized occupancy values across the monitored region, creating a continuous spatial representation of radio frequency activity. Each grouped region contributes a localized occupancy profile based on the cumulative signal data associated with its geographic coordinates. As the unmanned aerial vehicle continues its flight and gathers additional measurements, the processor updates the map in real time, refining the representation of signal distribution. This process allows the system to visualize how frequency usage varies across different areas and to identify regions where certain frequency bands are heavily occupied or exhibit unusual activity patterns.

In an embodiment, the processor is configured to refine the estimated location of the interference source by continuously updating the spatial correlation of signal intensity gradients using newly acquired measurements and previously stored measurement data, the processor recalculating the probable source location as the unmanned aerial vehicle moves through additional spatial positions and integrating altitude-based measurement variations to improve localization accuracy.

In an embodiment, the processor refines the estimated location of the interference source by maintaining an evolving spatial model that correlates signal intensity measurements collected over time and across different positions of the unmanned aerial vehicle. Each time the sensing unit acquires a new signal measurement, the processor compares the newly obtained signal intensity with previously stored measurements corresponding to nearby geographic coordinates. By examining how signal intensity values increase or decrease as the unmanned aerial vehicle moves from one spatial position to another, the processor identifies directional gradients that indicate whether the vehicle is approaching or moving away from the signal source. These gradients are calculated by evaluating the relative change in signal strength across successive measurement points and associating the changes with the direction and distance of movement between those points.

As the unmanned aerial vehicle continues to traverse additional spatial positions, the processor incorporates each new measurement into the existing dataset stored in the storage unit. The processor then recalculates the probable source location by correlating the updated signal intensity gradients with positional data from the latest flight segments. For example, if earlier measurements indicated that signal intensity increased when moving toward a certain region and newer measurements show further increases when approaching a more specific area within that region, the processor narrows the estimated source location accordingly. This iterative recalculation process allows the system to continuously improve the accuracy of the source estimate as more spatial data becomes available.

The processor also accounts for the movement trajectory of the unmanned aerial vehicle when refining the location estimate. By analyzing the direction of travel and the corresponding variation in signal intensity along that path, the processor determines the spatial direction in which signal strength consistently rises. If signal intensity increases when the vehicle moves in a particular direction and decreases when it moves away, the processor interprets this pattern as confirmation that the source lies along that direction. The processor integrates multiple such directional gradients derived from different flight paths and positions to form a converging estimate of the source location.

Altitude-based measurement variations are also incorporated into the refinement process. The processor examines how signal intensity changes when measurements are taken at different altitudes over the same or nearby horizontal positions. If signal strength increases as the unmanned aerial vehicle descends toward a certain location, the processor interprets this as an indication that the source may be located closer to ground level. Conversely, if signal intensity remains strong or increases at higher altitudes, the processor considers the possibility that the source is elevated, such as being located on a building or tower. By correlating altitude-dependent variations with horizontal position data, the processor refines the three-dimensional estimate of the source location rather than limiting the estimate to a two-dimensional surface.

In a practical example, the unmanned aerial vehicle may initially detect elevated signal intensity in a general area but without precise localization. As the vehicle flies across different paths over that area, each new set of measurements contributes additional gradient information. The processor observes that signal intensity increases when approaching a specific block of coordinates and decreases when moving away. If the vehicle then flies over the same coordinates at different altitudes and records stronger signals at lower altitudes, the processor integrates this information to conclude that the source is likely located within that area at ground level. With each pass and additional measurement, the processor recalculates the probable source location, progressively narrowing the estimated region.

This continuous updating process ensures that the source location estimate is not based on isolated measurements but on a comprehensive set of correlated spatial observations. By integrating newly acquired measurements with previously stored data, the processor refines the localization result in real time as the unmanned aerial vehicle moves. The use of signal intensity gradients across multiple positions and altitudes allows the processor to progressively converge on the most likely source location, improving the precision of the estimate as more spatial data is gathered.

In an embodiment, the processor is configured to identify the probable geographic origin of the interference source by determining a spatial path along which signal intensity progressively increases, identifying spatial coordinates corresponding to peak signal intensity measurements, and correlating the identified coordinates with directional reception angles recorded at those coordinates to determine an estimated source region.

In an embodiment, the processor identifies the probable geographic origin of the interference source by continuously analyzing the sequence of signal intensity measurements collected as the unmanned aerial vehicle moves across the monitored region and determining a spatial path along which the signal strength progressively increases. As the sensing unit captures radio frequency data at successive spatial positions, the processor compares each measurement with those recorded at previous positions and observes the trend in signal intensity relative to the direction of movement. When the processor detects that signal strength values consistently increase as the unmanned aerial vehicle moves along a particular trajectory, it interprets this pattern as an indication that the vehicle is approaching the region from which the signal is being emitted. By tracking this progression across multiple measurement points, the processor constructs a spatial path that represents the direction of increasing signal concentration.

As the unmanned aerial vehicle continues to traverse this path, the processor identifies specific spatial coordinates at which the signal intensity reaches local maximum levels. These peak intensity points are determined by comparing each measurement with those recorded immediately before and after it along the flight path. When a measurement is found to be significantly higher than adjacent readings, the processor marks the corresponding coordinate as a candidate location near the interference source. Over time, the processor may identify multiple such peak points if the unmanned aerial vehicle passes through the vicinity of the source from different directions or altitudes. Each of these points provides a reference for narrowing down the region where the source is likely located.

To refine the estimation, the processor correlates the identified peak intensity coordinates with the directional reception angles recorded at those same positions. For each peak measurement, the directional antenna orientation at the moment of acquisition indicates the direction from which the strongest signal component was received. The processor associates this directional information with the corresponding coordinate and projects the direction outward from that point. When multiple peak coordinates are identified across the flight path, the processor compares the directional projections from each of these points to determine whether they converge toward a common geographic area. If several directional projections from different peak positions intersect or overlap within a confined region, the processor interprets this region as the most probable origin of the interference source.

In a practical example, the unmanned aerial vehicle may initially detect moderate signal strength while flying over a wide area. As it moves closer to a specific location, the processor observes that the signal intensity gradually increases over successive measurement points. The processor records the coordinates where the intensity becomes significantly higher than surrounding measurements and identifies these as peak positions. At each of these positions, the directional antenna may indicate that the strongest reception occurs when oriented toward a particular direction. By projecting these directions from the peak coordinates, the processor may find that the projected paths intersect near a particular building or ground location. This convergence provides a spatial reference indicating the probable origin of the interference.

The processor continues to update this estimation as new measurements are acquired. If subsequent passes over the region result in additional peak intensity points that support the same convergence area, the processor increases the confidence in the estimated source region. If new peak points produce directional projections that slightly adjust the area of convergence, the processor recalibrates the estimated region accordingly. By combining progressive signal intensity trends with peak coordinate identification and directional correlation, the processor is able to determine an estimated source region that reflects both the spatial progression of signal strength and the directional characteristics of reception.

This process enables the processor to interpret the spatial relationship between movement trajectory, signal intensity variation, and directional reception to identify a region from which the interference is most likely originating. The identification of a path of increasing signal strength helps guide the localization process, while the correlation of peak measurement coordinates with directional reception angles allows the processor to narrow down the origin to a defined geographic area based on repeated spatial and directional observations.

In an embodiment, the processor is configured to detect abnormal signal concentration by performing sequential comparisons between measurements obtained at current spatial positions and baseline measurements stored in the storage unit for corresponding geographic areas, and identifying interference activity when signal intensity deviations exceed a predefined spatial variation threshold over a continuous sequence of measurement locations.

In an embodiment, the processor detects abnormal signal concentration by maintaining a set of baseline measurements in the storage unit that represent typical signal strength values previously recorded for specific geographic areas under normal operating conditions. These baseline measurements are formed either during an initial survey of the monitored region or from accumulated historical data collected during earlier flight operations. Each baseline record is associated with corresponding geographic coordinates and altitude references, enabling the processor to retrieve the most relevant baseline value when the unmanned aerial vehicle revisits or approaches the same location. As the sensing unit acquires new radio frequency measurements at current spatial positions, the processor identifies the nearest corresponding baseline entries based on positional proximity and retrieves the stored signal parameters for comparison.

The processor performs sequential comparisons by evaluating the difference between the newly acquired signal intensity and the stored baseline value associated with that geographic area. This comparison is not limited to a single measurement point but extends across a series of consecutive spatial positions along the flight path. The processor continuously calculates the magnitude of deviation at each position and determines whether the observed signal intensity is consistently higher than the expected baseline level. By analyzing a sequence of such deviations across multiple adjacent locations, the processor is able to detect patterns that indicate localized signal concentration rather than isolated measurement anomalies.

To ensure that detection is based on meaningful spatial behavior, the processor applies a predefined spatial variation threshold that represents the allowable range of deviation between current measurements and baseline values under normal environmental conditions. This threshold is used as a reference to determine when a deviation is significant enough to indicate potential interference activity. If the processor identifies that the difference between current signal intensity and baseline measurements exceeds this threshold at one location, it does not immediately classify the area as an interference zone. Instead, the processor continues to monitor subsequent measurements as the unmanned aerial vehicle moves through adjacent spatial positions. When deviations exceeding the threshold persist across a continuous sequence of measurement locations, the processor interprets this as evidence of abnormal signal concentration within that region.

For example, as the unmanned aerial vehicle flies over a communication-dense environment, the processor may compare current measurements with baseline data that represent normal signal levels for those coordinates. If the sensing unit records a signal strength that is slightly higher than the baseline at a single point, the processor may treat it as a temporary variation. However, if subsequent measurements taken at nearby positions consistently show signal strength values that remain significantly above the baseline threshold, the processor identifies a continuous pattern of deviation. This sustained difference across multiple positions indicates that the unmanned aerial vehicle is passing through an area where signal activity is unusually concentrated, which may be associated with an active interference source.

The processor further strengthens this detection by evaluating how the deviation changes across the sequence of measurement locations. If the magnitude of deviation increases as the unmanned aerial vehicle approaches a specific area and then decreases as it moves away, the processor recognizes a spatial concentration pattern centered around that location. This pattern allows the processor to distinguish between random fluctuations and consistent interference-related activity. The use of sequential comparison ensures that the identification of abnormal signal concentration is based on spatial continuity rather than isolated measurements that may be affected by transient environmental conditions.

Over time, as additional measurements are collected and stored, the processor can update the baseline dataset to reflect long-term changes in normal signal conditions while preserving records of previously identified abnormal regions. When the unmanned aerial vehicle passes through the same region during subsequent flights, the processor can again perform comparisons with the stored baseline values to determine whether the abnormal concentration persists. By continuously performing sequential comparisons and evaluating deviations against the spatial variation threshold across multiple adjacent measurement points, the processor is able to identify regions where signal intensity consistently departs from expected levels, allowing accurate recognition of interference activity within the monitored area.

In an embodiment, the processor is configured to control acquisition intervals of the sensing unit by dynamically adjusting measurement frequency based on the rate of change of positional data received from the positioning unit so that measurements are obtained more frequently in regions where rapid signal intensity variation is detected and less frequently in regions exhibiting stable signal conditions.

In an embodiment, the processor controls acquisition intervals of the sensing unit by continuously monitoring positional data received from the positioning unit and correlating the rate of positional change with variations observed in the signal intensity measurements. The processor evaluates parameters such as displacement between consecutive positional updates, changes in direction of movement, and variations in altitude to determine how rapidly the unmanned aerial vehicle is transitioning across different spatial regions. Based on this evaluation, the processor dynamically regulates when the sensing unit is instructed to acquire new radio frequency measurements, ensuring that the acquisition frequency adapts to the spatial conditions encountered during flight.

When the unmanned aerial vehicle enters a region where signal intensity values begin to change rapidly between successive measurements, the processor interprets this as an indication of a complex signal environment, possibly associated with proximity to an interference source or multiple active transmitters. In such situations, the processor reduces the spatial gap between consecutive acquisitions by triggering the sensing unit more frequently. This increased acquisition frequency allows the processor to capture finer spatial detail and detect subtle variations in signal strength that may occur over short distances. For example, as the unmanned aerial vehicle approaches an area where signal levels begin to rise sharply, the processor increases the rate at which measurements are taken so that the progression of signal intensity can be recorded with greater resolution. This provides a more detailed dataset for analyzing spatial gradients and identifying the precise region where signal concentration is highest.

Conversely, when the processor detects that signal intensity remains relatively stable over a sequence of spatial positions and that the positional data indicates smooth and consistent movement without significant directional changes, it adjusts the acquisition intervals to occur less frequently. This reduction is achieved by increasing the spatial displacement required before the next measurement is triggered. By doing so, the processor avoids collecting redundant measurements in areas where signal conditions are uniform and do not exhibit meaningful variation. For instance, while the unmanned aerial vehicle is flying over an open area with minimal signal activity and where consecutive measurements show similar intensity values, the processor allows a larger spatial interval to pass before initiating the next acquisition. This ensures efficient use of sensing resources and storage capacity while maintaining adequate spatial coverage.

The processor determines the rate of change of positional data by analyzing differences between successive positional updates in terms of coordinate displacement and movement direction. When these positional changes are accompanied by noticeable variation in signal intensity values, the processor interprets the combination as an indicator of a region where signal conditions are evolving. In response, it shortens the acquisition interval so that each positional change is closely monitored with corresponding signal measurements. If, on the other hand, positional updates indicate consistent movement along a uniform trajectory and the associated signal measurements show minimal variation, the processor increases the interval between acquisitions, allowing the sensing unit to capture data at a lower frequency without compromising the ability to represent the signal environment accurately.

In a practical scenario, as the unmanned aerial vehicle travels across a city landscape, it may encounter areas where signal intensity increases significantly near clusters of transmitters. The processor detects rapid variation in signal levels along with positional changes and immediately adjusts the acquisition pattern so that measurements are captured at closely spaced positions. This produces a dense set of data points that can later be used to determine precise spatial gradients and identify localized sources. Once the vehicle moves beyond that region and enters an area where signal intensity stabilizes and positional movement remains uniform, the processor gradually increases the interval between acquisitions, thereby conserving processing and storage resources while still maintaining coverage of the area.

By dynamically controlling acquisition intervals based on the combined assessment of positional change and signal variation, the processor ensures that measurement density is concentrated in areas where detailed spatial analysis is required and reduced in areas where conditions are stable. This adaptive regulation enables the sensing unit to focus its acquisition activity on regions where meaningful signal transitions occur, allowing the collected data to more accurately reflect the spatial distribution of radio frequency activity across the monitored region.

In an embodiment, the processor is configured to derive a directional reception pattern by accumulating signal intensity measurements associated with different orientation angles of the directional antenna over a sequence of flight positions, and identifying an angular region corresponding to maximum cumulative signal intensity for use in determining a probable direction toward an interference source.

In an embodiment, the processor derives a directional reception pattern by continuously collecting and organizing signal intensity measurements in association with the corresponding orientation angles of the directional antenna as the unmanned aerial vehicle moves through successive flight positions. At each acquisition instance, the sensing unit records the strength of received radio frequency signals while the positioning unit provides orientation data that reflects the angular direction in which the directional antenna is pointed at that moment. The processor stores these paired values, creating a sequence of records in which each signal intensity measurement is linked to a specific antenna orientation and spatial coordinate. As the unmanned aerial vehicle proceeds along its flight path and the orientation of the antenna changes due to maneuvering, stabilization adjustments, or environmental influences, additional measurements are accumulated across a range of different angular positions.

Over time, the processor aggregates these measurements by grouping them according to their associated orientation angles and analyzing how signal intensity varies across the different angular directions. Instead of evaluating each measurement in isolation, the processor combines multiple signal readings collected at similar orientation angles across different spatial positions. By accumulating intensity values associated with each angular direction, the processor forms a cumulative representation that reflects how consistently strong the received signal is when the antenna is oriented toward particular directions. This accumulation allows the processor to reduce the impact of temporary fluctuations, reflections, or noise that may affect individual measurements, as repeated observations across different positions provide a more stable representation of directional reception.

As the dataset grows, the processor compares the accumulated signal intensity values across the range of orientation angles to identify an angular region where the cumulative intensity is significantly higher than in other directions. The processor evaluates not only the maximum single measurement but also the overall concentration of high-intensity readings within a particular angular span. For example, if measurements recorded while the antenna is oriented within a certain angular sector consistently show stronger signal levels across multiple flight positions, the processor identifies that sector as having a dominant directional characteristic. The processor then defines this sector as the angular region corresponding to maximum cumulative signal intensity.

The determination of this angular region is carried out by examining how the accumulated signal strength varies gradually across adjacent orientation angles. If a continuous range of orientations produces consistently higher intensity values compared to neighboring angles, the processor interprets this as an indication that the interference source is located in that general direction relative to the unmanned aerial vehicle. The processor further refines this pattern by considering measurements collected at different spatial positions to ensure that the identified angular region remains consistent despite changes in location. If the same angular sector repeatedly corresponds to higher cumulative signal intensity across multiple segments of the flight path, the processor increases the confidence in identifying that direction as the probable direction toward the interference source.

In a practical example, as the unmanned aerial vehicle moves through the monitored region, the directional antenna may face multiple directions due to flight path adjustments. At each orientation, the sensing unit records signal intensity levels. Over time, the processor observes that whenever the antenna is oriented toward a particular range of angles, the recorded signal intensity tends to be higher compared to other orientations. By accumulating and comparing these readings, the processor forms a directional reception pattern showing a concentration of strong signals within that angular range. Even if the vehicle changes position or altitude, the persistence of higher cumulative intensity within the same angular sector indicates that the source of the signal is located in that direction.

The processor then uses this identified angular region as a directional reference for estimating the probable direction toward the interference source. By associating the angular sector of maximum cumulative signal intensity with the spatial orientation of the unmanned aerial vehicle at the time of measurement, the processor determines the direction in which the source is most likely located. This directional reception pattern can then be combined with positional data collected at different flight positions to support further localization processes. Through continuous accumulation and analysis of orientation-linked signal intensity measurements, the processor develops a stable and reliable directional indication that reflects the consistent reception characteristics observed across the monitored region.

In an embodiment, the processor is configured to utilize spatial diversity of the plurality of antenna elements by comparing time-synchronized signal measurements obtained from each antenna element to determine relative phase and strength differences across the antenna elements, and using the relative differences to enhance directional estimation associated with the interference source.

In an embodiment, the processor utilizes spatial diversity of the plurality of antenna elements by coordinating the simultaneous acquisition of signal measurements from each antenna element at the same acquisition instant and associating each measurement with a common time reference. The sensing unit captures signal strength values and associated reception characteristics from each antenna element in a synchronized manner so that all measurements represent the same signal environment at the same spatial position of the unmanned aerial vehicle. The processor then processes these synchronized measurements as a collective dataset, allowing it to examine how the received signal is distributed across the antenna elements positioned at different spatial locations and orientations on the unmanned aerial vehicle structure.

Because the antenna elements are arranged in a spaced configuration, the signal transmitted from an interference source does not reach each antenna element with identical characteristics. The processor evaluates the relative signal strength values across the antenna elements to determine which elements receive stronger signals and which receive weaker signals at the same moment. This relative comparison enables the processor to identify a directional bias in signal reception, as the antenna elements positioned closer to the direction of the incoming signal tend to record higher intensity values. In addition to strength differences, the processor also analyzes the relative phase differences between the signals received at each antenna element. The phase relationship reflects the slight variation in the time at which the signal wavefront reaches each antenna element due to their spatial separation. By examining how the phase of the received signal differs across the antenna elements, the processor obtains additional information about the direction from which the signal is arriving.

The processor combines the relative strength differences and phase differences to interpret the spatial reception pattern across the antenna arrangement. For example, if one antenna element consistently receives a stronger signal and its associated phase measurement indicates that the signal wavefront reaches that element earlier than the others, the processor infers that the signal is arriving from the direction corresponding to the spatial position of that antenna element. If the signal strength gradually increases across the antenna elements arranged along a particular axis, and the phase differences follow a consistent progression along the same axis, the processor recognizes this as a directional gradient indicating the direction of the interference source relative to the orientation of the unmanned aerial vehicle.

As the unmanned aerial vehicle continues to move and acquire additional synchronized measurement sets, the processor accumulates multiple instances of relative strength and phase comparisons. By observing how these relative differences change as the spatial position of the unmanned aerial vehicle shifts, the processor refines its interpretation of the incoming signal direction. For instance, if the same antenna element repeatedly records stronger signals across multiple positions while the relative phase differences maintain a consistent pattern, the processor strengthens the directional estimation associated with that side of the antenna arrangement. Conversely, if the relative differences shift as the unmanned aerial vehicle changes position, the processor analyzes the progression of these shifts to determine whether the vehicle is moving toward or away from the interference source.

In a practical scenario, as the unmanned aerial vehicle approaches a location where an interference source is active, the antenna elements positioned on the side facing the source may record progressively stronger signals, while the opposite elements register weaker reception. At the same time, the phase of the signal received at the nearer antenna elements may lead that of the others. The processor evaluates these combined differences to derive a directional indication that complements the directional antenna measurements. Over multiple measurement instances, the processor integrates this spatial diversity information with positional data to improve the reliability of the directional estimation.

By comparing time-synchronized signal measurements across the plurality of antenna elements and evaluating both strength and phase relationships, the processor derives a spatially informed interpretation of signal arrival characteristics. This comparative analysis allows the system to extract directional information even in complex environments where reflections or signal variations may affect individual measurements. The use of spatial diversity enhances the ability to determine the direction associated with the interference source by providing multiple simultaneous reception perspectives from different points on the unmanned aerial vehicle structure.

In the present system, each of the elements forming the arrangement is implemented as a tangible hardware component integrated with the unmanned aerial vehicle to enable real-world operation and signal acquisition. The sensing unit is realized as a physical radio frequency reception assembly that includes one or more antenna structures, radio frequency front-end circuitry, and signal conditioning hardware configured to capture electromagnetic signals across multiple frequency ranges. The directional antenna and omnidirectional antenna are implemented as conductive radiating elements mounted on the aerial vehicle structure, physically oriented to receive signals from different spatial directions. The positioning unit is a hardware-based navigation arrangement that includes a satellite signal receiver, altitude sensing circuitry, and motion detection sensors such as inertial measurement components that continuously provide real-time geographic coordinates, elevation, velocity, and orientation data. The processor is implemented as an onboard electronic computing device comprising a microprocessor or digital processing circuit configured to execute stored instructions, perform signal processing operations, synchronize measurement data, and compute spatial relationships based on inputs from the sensing and positioning units. The storage unit is a physical non-volatile memory device that retains recorded measurements, positional information, and processed data in structured electronic form, allowing the information to be retrieved and analyzed during and after flight operations. The communication unit is a hardware-based wireless transmission interface that includes a radio transceiver circuit and antenna arrangement configured to send processed information to a remote receiving station through electromagnetic communication links. All of these components are mounted within or on the structural frame of the unmanned aerial vehicle using mechanical supports, electrical interconnections, and protective housings that provide power distribution, signal routing, and environmental protection. Each unit performs a defined physical function through dedicated circuitry and electromechanical structures, ensuring that the system operates as an integrated hardware-based apparatus capable of acquiring, processing, storing, and transmitting radio frequency and spatial data during aerial movement.

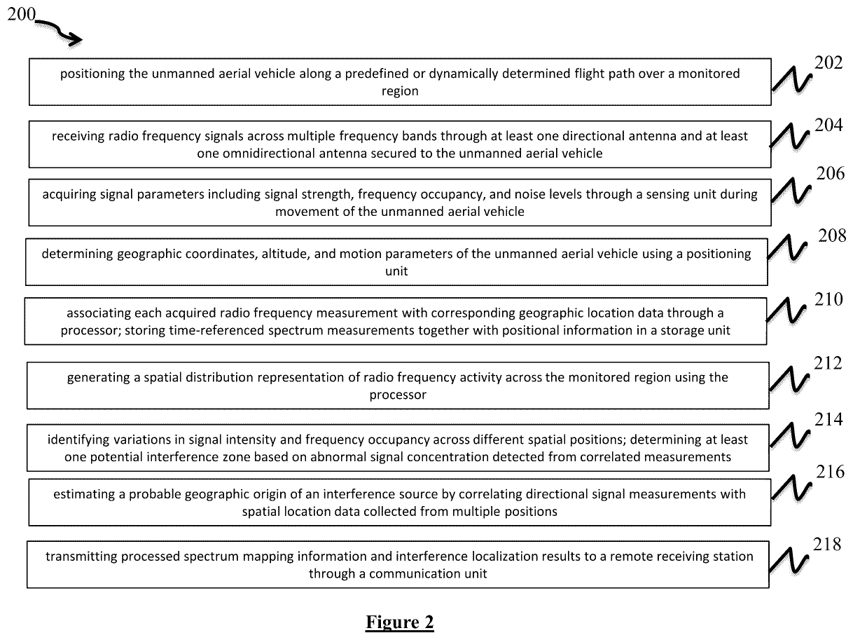

Referring to FIG. 2, a flow chart for a method for autonomous drone-based spectrum mapping and interference localization using a system mounted on an unmanned aerial vehicle, the method comprising the steps of is illustrated. The method 200 comprises:

At step 202, the method 200 positioning the unmanned aerial vehicle along a predefined or dynamically determined flight path over a monitored region;

At step 204, the method 200 receiving radio frequency signals across multiple frequency bands through at least one directional antenna and at least one omnidirectional antenna secured to the unmanned aerial vehicle;

At step 206, the method 200 acquiring signal parameters including signal strength, frequency occupancy, and noise levels through a sensing unit during movement of the unmanned aerial vehicle;

At step 208, the method 200 determining geographic coordinates, altitude, and motion parameters of the unmanned aerial vehicle using a positioning unit;

At step 210, the method 200 associating each acquired radio frequency measurement with corresponding geographic location data through a processor; storing time-referenced spectrum measurements together with positional information in a storage unit;

At step 212, the method 200 generating a spatial distribution representation of radio frequency activity across the monitored region using the processor;

At step 214, the method 200 identifying variations in signal intensity and frequency occupancy across different spatial positions; determining at least one potential interference zone based on abnormal signal concentration detected from correlated measurements;

At step 216, the method 200 estimating a probable geographic origin of an interference source by correlating directional signal measurements with spatial location data collected from multiple positions; and

At step 218, the method 200 transmitting processed spectrum mapping information and interference localization results to a remote receiving station through a communication unit.

In an embodiment, receiving the radio frequency signals comprises capturing signals through a wideband receiver enclosed within a vibration-isolated and electromagnetically shielded housing mounted on the unmanned aerial vehicle to maintain measurement stability during aerial movement.

In an embodiment, acquiring the signal parameters further comprises measuring signal strength and noise level at periodic spatial intervals determined based on speed and direction of the unmanned aerial vehicle to ensure uniform coverage of the monitored region;

In an embodiment, determining the geographic coordinates, altitude, and motion parameters comprises obtaining satellite-based navigation data synchronized with altitude sensing and motion detection measurements to provide accurate spatial tagging of each radio frequency measurement.

In an embodiment, associating each acquired radio frequency measurement with the corresponding geographic location data comprises time-synchronizing signal acquisition events with positional updates to create a sequence of spatially referenced measurement records.

In an embodiment, generating the spatial distribution representation comprises integrating sequential measurements collected along the flight path to form a continuous coverage map representing variations in frequency occupancy across the monitored region.

In an embodiment, identifying variations in signal intensity further comprises comparing signal measurements obtained at different altitudes to determine vertical distribution of radio frequency activity within the monitored region.

In an embodiment, determining the potential interference zone comprises detecting abrupt increases in signal strength within specific frequency bands when compared with previously recorded baseline measurements stored in the storage unit.

In an embodiment, estimating the probable geographic origin of the interference source comprises analyzing directional signal measurements obtained from the directional antenna at multiple spatial positions to derive a location estimate based on angular variation and signal intensity gradients.

In an embodiment, storing the time-referenced spectrum measurements comprises recording positional coordinates, altitude information, motion parameters, and corresponding signal characteristics in a non-volatile memory for subsequent reconstruction of a detailed spectrum map.

The present invention relates to an autonomous drone-based spectrum mapping and interference localization system and method thereof, wherein the operational functionality is governed by a coordinated sensing, positioning, and processing arrangement configured to execute a structured measurement and localization technique. The system is mounted on an unmanned aerial vehicle and comprises a sensing unit, a positioning unit, a processor, a storage unit, and a communication unit integrated within a stabilized structural housing. The processor is configured to execute a sequence of operations that enable acquisition of radio frequency signals, spatial tagging of measurements, generation of spectrum distribution data, and determination of interference source location through spatial correlation of collected signal characteristics.

During operation, the unmanned aerial vehicle is positioned along a predefined or dynamically determined flight path covering a monitored geographic region. The positioning unit continuously determines geographic coordinates, altitude, velocity, and orientation parameters of the unmanned aerial vehicle using satellite-based navigation signals and onboard motion detection sensing elements. The processor receives time-referenced positional data from the positioning unit and establishes a synchronization mechanism that aligns each positional update with corresponding radio frequency measurements acquired by the sensing unit. This synchronization ensures that each measurement is accurately recorded with spatial reference data to enable generation of a detailed spectrum map.

The sensing unit comprises at least one directional antenna and at least one omnidirectional antenna connected to a wideband receiver arrangement capable of capturing radio frequency signals across multiple frequency bands. As the unmanned aerial vehicle moves through the monitored region, the sensing unit continuously samples signal parameters including signal strength, frequency occupancy, and background noise levels. The processor controls the acquisition intervals based on the speed and movement of the unmanned aerial vehicle, ensuring that measurements are taken at consistent spatial intervals rather than at fixed time intervals. This approach ensures uniform coverage and improves spatial resolution of the resulting spectrum map.

The technique executed by the processor begins with the collection of baseline signal measurements across the monitored region. These initial measurements are stored in the storage unit along with their associated positional data. The processor analyzes the collected measurements to determine normal frequency occupancy patterns and establishes reference values for signal strength and noise levels across different areas. As the unmanned aerial vehicle continues along its flight path, newly acquired measurements are compared with the stored reference values to detect deviations indicative of abnormal signal activity or interference.

When variations in signal intensity are detected, the processor initiates a spatial comparison process that evaluates signal measurements collected from adjacent positions. The technique calculates differences in signal strength across multiple spatial points to identify regions where signal concentration increases significantly. These regions are marked as potential interference zones. The processor then performs a refinement process by analyzing directional measurements obtained from the directional antenna. The directional antenna orientation is continuously monitored and recorded by the positioning unit, allowing the processor to associate signal measurements with specific reception angles.

The localization technique is based on correlating signal intensity gradients and directional reception data collected at multiple spatial positions. As the unmanned aerial vehicle traverses different locations, the processor identifies patterns in signal strength variation relative to position changes. When the signal intensity increases consistently along a particular direction of movement, the processor interprets this as an indication of proximity to the interference source. By combining directional reception angles with positional coordinates, the processor estimates the probable geographic origin of the interference. This estimation is refined continuously as additional measurements are acquired from different altitudes and positions.

The processor further enhances localization accuracy by comparing measurements obtained at varying altitudes. By analyzing how signal intensity changes with altitude variation, the technique distinguishes between ground-based interference sources and elevated transmitters. The system integrates altitude-dependent measurements with horizontal positional data to generate a three-dimensional representation of radio frequency distribution. This three-dimensional mapping capability allows the processor to determine whether an interference source is located at ground level, within a building, or at an elevated structure.

To detect transient interference events, the processor continuously compares successive measurements collected at short intervals. Sudden increases or decreases in signal strength within specific frequency bands are identified as potential temporary interference occurrences. The processor records the time and location of such events and stores the information in the storage unit. If repeated transient signals are detected in a particular area, the technique increases the measurement density in that region by adjusting acquisition intervals and flight positioning to gather additional data for improved analysis.

The processor is further configured to generate a dynamic spatial spectrum distribution map by integrating all collected measurements. Each measurement is plotted based on its associated geographic coordinates and altitude data. The processor aggregates these measurements to form a continuous representation of frequency occupancy across the monitored region. Areas with consistent frequency usage are identified as normal operational zones, while regions with abnormal signal patterns are highlighted as potential interference zones.

As the unmanned aerial vehicle continues to move, the processor continuously updates the interference localization estimate. The technique recalculates the probable source location by combining new measurements with previously stored data. This iterative refinement process improves accuracy over time and enables the system to track moving interference sources. The processor maintains a record of estimated source positions and compares new data against earlier estimates to determine whether the interference source is stationary or mobile.

The storage unit maintains a structured dataset comprising time-stamped signal measurements, positional coordinates, altitude information, directional reception angles, and detected interference indicators. This dataset allows reconstruction of the spectrum map after completion of the flight sequence and supports further analysis at a remote receiving station. The communication unit transmits processed information to the remote receiving station in real time, including spatial spectrum maps, identified interference zones, and estimated source locations. The transmitted data enables immediate visualization and response by monitoring personnel.

The structural housing that encloses the sensing unit, processor, and storage unit is designed to minimize vibration and electromagnetic interference. Vibration isolation elements ensure that antenna alignment remains stable during flight, preventing distortion in directional measurements. Electromagnetic shielding reduces the influence of onboard propulsion components on signal reception. Thermal dissipation pathways are integrated into the housing to maintain operating temperature within a predetermined range, ensuring consistent performance of the sensing and processing components during extended monitoring missions.

The processor is further configured to autonomously control sensing operations without requiring continuous human intervention. The flight path stored in the storage unit is executed by the unmanned aerial vehicle, and the sensing unit continuously collects spectrum data along the route. If abnormal signal patterns are detected, the processor can adjust measurement density by increasing acquisition frequency or modifying altitude to capture additional data from different perspectives. This adaptive behavior enhances the system's ability to localize interference sources accurately.

Through the combination of synchronized sensing, spatial tagging, signal comparison, directional analysis, and iterative localization, the system provides a comprehensive techniqueic approach for real-time spectrum mapping and interference detection. The integration of positional data with signal measurements enables the processor to construct a detailed representation of radio frequency activity and to identify the geographic origin of interference sources with improved precision. The method ensures systematic coverage of the monitored region, continuous refinement of localization estimates, and efficient generation of actionable spectrum information for communication monitoring and regulatory applications.

The autonomous drone-based spectrum mapping and interference localization system comprises an unmanned aerial platform carrying a device structure configured for spectrum sensing and analysis. The device structure includes a rigid mounting frame integrated with the drone body, designed to maintain antenna alignment and minimize electromagnetic interference from onboard propulsion components. The structure supports a multi-antenna arrangement including directional antenna elements configured for angular signal measurement and omnidirectional antenna elements configured for wide-area spectrum capture. The structural assembly includes shielding compartments to isolate sensing electronics from vibration and electrical noise generated by the drone motors.

The sensing unit is configured to capture radio frequency signals across multiple frequency bands using a wideband receiver circuit integrated within the device structure. The sensing unit continuously samples signal strength, frequency occupancy, modulation characteristics, and noise levels while the drone traverses a predefined or dynamically adjusted flight path. The positioning unit comprises a satellite-based navigation receiver configured to determine precise geographic coordinates, altitude, and velocity data, which are synchronized with spectrum measurements to generate geospatially tagged signal records.

The processing unit is embedded within the device structure and is configured to perform real-time analysis of collected spectrum data. The processing unit evaluates signal intensity variations, detects abnormal emissions, and identifies frequency bands exhibiting interference patterns. Through coordinated data acquisition at multiple spatial points, the processing unit estimates the direction of arrival of signals using directional antenna measurements. By correlating signal strength gradients and directional data across flight positions, the system computes the probable location of interference sources.

The method thereof includes initiating an autonomous flight sequence over a designated monitoring region, during which the sensing unit continuously collects spectral data. The processing unit associates each measurement with positional information to construct a spatial distribution profile of signal characteristics. The system performs iterative comparison of measurements collected at multiple locations to determine regions of abnormal signal concentration. The processing unit applies triangulation and signal gradient estimation techniques to identify the geographic origin of interference sources.

The device structure is further designed to support modular expansion, allowing the integration of additional sensing elements for specialized monitoring applications. The housing arrangement includes thermal dissipation channels to maintain operational stability of electronic components and vibration-dampening mounts to ensure consistent signal acquisition accuracy. The structural device configuration enables secure attachment to different drone models, ensuring adaptability across varying operational platforms.

The system further includes a communication unit configured to transmit processed spectrum maps and interference localization data to a ground station in real time. The ground station receives the data and reconstructs a visual representation of spectrum occupancy across the monitored region. The method enables continuous updating of the map as the drone moves, providing dynamic insight into changing radio frequency conditions.

In operation, the drone autonomously navigates through predetermined flight corridors, periodically adjusting altitude and position to enhance localization accuracy. As the drone collects multiple measurements from varying perspectives, the processing unit refines its estimation of interference source location. This iterative approach improves localization precision and enables detection of both stationary and mobile interference sources.

The invention thereby provides a comprehensive machine-integrated device structure, system configuration, and operational method that collectively enable accurate spectrum mapping, rapid detection of unauthorized transmissions, and precise localization of interference sources. The integration of structural stability, autonomous sensing, and real-time processing allows the system to operate efficiently in complex and dynamic environments, providing a scalable solution for regulatory monitoring, network optimization, and security surveillance of wireless communication infrastructures.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. An autonomous drone-based spectrum mapping and interference localization system comprising:
an unmanned aerial vehicle structure;
a sensing unit secured to the unmanned aerial vehicle structure and configured to receive radio frequency signals across multiple frequency bands through at least one directional antenna and at least one omnidirectional antenna;
a positioning unit configured to determine geographic coordinates, altitude, and motion parameters of the unmanned aerial vehicle;
a processor operatively connected to the sensing unit and the positioning unit and configured to acquire radio frequency measurements and associate the radio frequency measurements with spatial location data;
a storage unit configured to store collected spectrum data and associated positional information; and
a communication unit configured to transmit processed spectrum information to a remote receiving station, wherein the processor is further configured to generate a spatial spectrum distribution map and determine a location of an interference source based on variations in signal strength and directional measurements obtained during flight, wherein the processor is configured to implement a coordinated measurement sequencing operation in which the sensing unit is triggered to acquire radio frequency measurements at successive spatial intervals determined from motion parameters obtained from the positioning unit, the processor further associating each acquired measurement with a corresponding spatial reference by aligning time-stamped signal acquisition instances with positional updates so as to generate a continuous spatial record of frequency occupancy as the unmanned aerial vehicle traverses the monitored region, and wherein the processor is configured to analyze differences in received signal parameters across the plurality of antenna elements by simultaneously acquiring signal measurements from each antenna element, comparing relative signal strength values received at each antenna element at the same time instance, and determining spatial reception gradients across the antenna arrangement so as to derive additional directional information associated with a detected interference source.

2. The system of claim 1, wherein the sensing unit comprises a wideband receiver arrangement mounted within a vibration-isolated enclosure fixed to the unmanned aerial vehicle structure, the enclosure including electromagnetic shielding layers to reduce electrical noise from propulsion components and maintain signal acquisition accuracy during flight, and wherein the directional antenna is mounted on a stabilized support assembly that maintains angular alignment during movement of the unmanned aerial vehicle, and wherein the processor is configured to determine direction of arrival of received signals based on angular measurements associated with the directional antenna orientation.

3. The system of claim 1, wherein the positioning unit comprises a satellite navigation receiver integrated with an altitude sensing element and a motion detection element, and wherein the processor is configured to synchronize positional data with radio frequency measurements collected at corresponding time intervals to enable spatial tagging of each measurement, and wherein the processor is configured to continuously compare signal strength measurements obtained at different spatial locations along a flight path to identify regions of abnormal signal concentration indicative of interference activity.

4. The system of claim 1, wherein the processor is further configured to estimate a probable geographic origin of an interference source by correlating directional measurements with signal intensity gradients recorded at multiple positions of the unmanned aerial vehicle during movement across a monitored region, and wherein the sensing unit comprises a plurality of antenna elements arranged in a spaced configuration on the unmanned aerial vehicle structure to provide spatial diversity in signal reception, and wherein the processor is configured to analyze differences in received signal parameters across the plurality of antenna elements to improve localization accuracy.

5. The system of claim 1, wherein the storage unit comprises a non-volatile memory arranged to record time-stamped spectrum measurements together with corresponding geographic coordinates, altitude data, and motion parameters to enable reconstruction of a spatially resolved spectrum map after completion of a flight sequence, and wherein the communication unit is configured to transmit processed data packets containing spectrum occupancy information, interference indicators, and geographic reference points to the remote receiving station in real time using a wireless communication link.

6. The system of claim 1, wherein the processor is configured to generate a dynamic coverage map representing frequency usage distribution over a monitored area by integrating sequential radio frequency measurements collected at different flight positions.

7. The system of claim 5, wherein the processor is configured to perform a multi-stage comparison of signal strength measurements obtained at consecutive spatial locations by retrieving previously stored measurements from the storage unit, computing relative variations between newly acquired measurements and stored reference values corresponding to nearby spatial coordinates, and identifying localized clusters of signal intensity increase by analyzing cumulative variation patterns across adjacent measurement points along the flight path.

8. The system of claim 6, wherein the processor is configured to estimate the probable geographic origin of the interference source by determining directional reception angles associated with each acquired measurement from the directional antenna orientation data, correlating the directional reception angles with corresponding signal intensity values at multiple spatial positions, and deriving a converging spatial estimate by identifying overlapping directional regions that correspond to progressively increasing signal intensity levels recorded during movement of the unmanned aerial vehicle.

9. The system of claim 3, wherein the processor is configured to determine the direction of arrival of received signals by continuously monitoring the orientation of the stabilized support assembly carrying the directional antenna, associating each orientation position with a corresponding signal intensity value, and constructing a directional reception profile over a sequence of spatial positions so as to determine a dominant reception direction corresponding to a suspected interference source.

10. The system of claim 4, wherein the processor is configured to synchronize positional data with radio frequency measurements by assigning time-referenced identifiers to each positional update received from the positioning unit and aligning the time-referenced identifiers with corresponding signal acquisition events from the sensing unit so that each measurement is tagged with geographic coordinates, altitude data, and motion parameters representing the exact spatial state of the unmanned aerial vehicle at the moment of acquisition.

11. The system of claim 7, wherein the processor is configured to store time-stamped spectrum measurements in the storage unit in a structured sequence such that each stored record includes a positional coordinate reference, altitude information, directional antenna orientation, and corresponding signal parameters, and wherein the processor retrieves and organizes the stored records in chronological order to reconstruct a spatially resolved representation of spectrum activity over the monitored region.

12. The system of claim 10, wherein the processor is configured to generate the dynamic coverage map by aggregating sequential radio frequency measurements collected at different flight positions, grouping the measurements based on spatial proximity, and computing localized frequency occupancy values for each grouped spatial region based on cumulative signal data associated with the corresponding geographic coordinates.

13. The system of claim 1, wherein the processor is configured to refine the estimated location of the interference source by continuously updating the spatial correlation of signal intensity gradients using newly acquired measurements and previously stored measurement data, the processor recalculating the probable source location as the unmanned aerial vehicle moves through additional spatial positions and integrating altitude-based measurement variations to improve localization accuracy.

14. The system of claim 6, wherein the processor is configured to identify the probable geographic origin of the interference source by determining a spatial path along which signal intensity progressively increases, identifying spatial coordinates corresponding to peak signal intensity measurements, and correlating the identified coordinates with directional reception angles recorded at those coordinates to determine an estimated source region.

15. The system of claim 5, wherein the processor is configured to detect abnormal signal concentration by performing sequential comparisons between measurements obtained at current spatial positions and baseline measurements stored in the storage unit for corresponding geographic areas, and identifying interference activity when signal intensity deviations exceed a predefined spatial variation threshold over a continuous sequence of measurement locations; and wherein the processor is configured to control acquisition intervals of the sensing unit by dynamically adjusting measurement frequency based on the rate of change of positional data received from the positioning unit so that measurements are obtained more frequently in regions where rapid signal intensity variation is detected and less frequently in regions exhibiting stable signal conditions.

16. The system of claim 3, wherein the processor is configured to derive a directional reception pattern by accumulating signal intensity measurements associated with different orientation angles of the directional antenna over a sequence of flight positions, and identifying an angular region corresponding to maximum cumulative signal intensity for use in determining a probable direction toward an interference source.

17. The system of claim 7, wherein the processor is configured to utilize spatial diversity of the plurality of antenna elements by comparing time-synchronized signal measurements obtained from each antenna element to determine relative phase and strength differences across the antenna elements, and using the relative differences to enhance directional estimation associated with the interference source.
